(19) United States
(12) Patent Application Publication
(10) Pub. No.: US 2005/0264697 A1
(43) Pub. Date: Dec. 1, 2005

(54) Burst frequency discrimination circuit

(75) Inventors: Hisaji Murata, Osaka (JP); Toshihiro Miyoshi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/133,224

(22) Filed: May 20, 2005

(30) Foreign Application Priority Data
May 27, 2004 (JP) 2004-157073

(51) Int. Cl. H04N 9/65

(52) U.S. Cl. 348/557; 348/558

(57) ABSTRACT

A picture signal processing circuit capable of processing picture signals of various broadcast systems including the SECAM system, the PAL system and the NTSC system, wherein an FM demodulation circuit for demodulating a SECAM signal is used also as a portion of a burst frequency discrimination circuit. An input picture signal is demodulated by the FM demodulation circuit to obtain a frequency component thereof, and then a burst signal portion thereof is extracted by a burst extracting circuit. The extracted demodulated signal is integrated by an integration circuit, and compared with a predetermined value by a comparator, based on which the burst frequency is determined. Therefore, it is possible to instantaneously determine the burst frequency, and the circuit scale is reduced by sharing the FM demodulation circuit.

### CROSS REFERENCE TO RELATED APPLICATION

This non-provisional application claims priority under 35 U.S.C. § 119(a) on Patent Application No. 2004-157073 filed in Japan on May 27, 2004, the entire contents of which are hereby incorporated by reference.

### BACKGROUND OF THE INVENTION

The present invention relates to a burst frequency discrimination circuit for determining a broadcast system by determining the burst frequency of a broadcast signal for use in a picture signal process handling different types of broadcast signals such as NTSC signals and PAL signals, for example.

There are various color television broadcast systems such as NTSC and PAL. For example, the color subcarrier frequency is 3.579545 MHz in the NTSC system and 4.43361875 MHz in the PAL system. There are some regions in Europe where signals of different broadcast systems can be received, and there are products such as TV sets and VCRs that are capable of handling color television broadcast signals of different broadcast systems. A product of this type needs to be manually set to a certain broadcast system, or it needs to be provided with an automatic broadcast system determination device to automatically determine the broadcast system of the picture signal being received, so that the received signal is processed accordingly.

A method for discriminating NTSC and PAL from each other (among various color television broadcast systems) is to use the color subcarrier frequency.

A conventional broadcast system determination device of this type is disclosed in Japanese Laid-Open Patent Publication No. 9-65343, for example. FIG. 6 is a block diagram showing a configuration of the conventional broadcast system determination device. Referring to FIG. 6, the conventional broadcast system determination device includes: a burst extracting circuit 101 for extracting a burst signal from an input picture signal (Croma signal); an ACC (Auto Color Control) circuit 102 for controlling the amplitude of the burst signal to a predetermined value; an APC (Auto Phase Control) circuit 111 for generating an oscillation signal having the same frequency as that of the burst signal output from the ACC circuit 102; an automatic discrimination circuit 107 for automatically determining the broadcast system and outputting the determination result as a control signal; and a switch 108 for receiving the control signal output from the automatic discrimination circuit 107. The switch 108 selects one of an NTSC crystal oscillator 109 and a PAL crystal oscillator 110 based on the received control signal.

The APC circuit 111 includes: a phase detection circuit 103 for detecting the phase of the burst signal output from the ACC circuit 102 by using a signal output from a phase difference circuit 106; a low pass filter (LPF) 104 for removing high frequency components of the signal output from the phase detection circuit 103 to output a low frequency signal; a VCO (Voltage Controlled Oscillator) 105 for controlling the oscillation frequency based on the low frequency signal output from the LPF 104; and the phase difference circuit 106 for adding a predetermined phase difference to the oscillation signal output from the VCO 105.

An operation of the conventional broadcast system determination device having such a configuration will now be described. When a Croma signal is received, the burst extracting circuit 101 extracts a burst signal therefrom and outputs the burst signal to the ACC circuit 102. The ACC circuit 102 detects the amplitude of the burst signal and controls the amplitude to a predetermined amplitude value, after which the ACC circuit 102 outputs the burst signal to the APC circuit 111. Thus, the color depth of the picture signal can be kept constant.

The APC circuit 111 performs a phase control operation so that a clock signal having the same frequency and the same phase as those of the burst signal from the ACC circuit 102 is output as an oscillation signal. First, the phase detection circuit 103 detects the phase of the burst signal output from the ACC circuit 102. The detected phase is filtered through the LPF 104, where high frequency components thereof are removed, and is output to the VCO 105. The VCO 105, being connected to the NTSC crystal oscillator 109 or to the PAL crystal oscillator 110 via the switch 108, controls the oscillation frequency of the oscillation signal output from the oscillator connected thereto according to the signal output from the LPF 104, and outputs the obtained signal to a color demodulation circuit as a reference subcarrier for color demodulation. Thus, the APC circuit 111 controls the oscillation frequency of the oscillator being selected by the switch 108 based on the burst signal from the ACC circuit 102 so that the phase error output from the phase detection circuit 103 is zero and outputs the reference subcarrier.

A burst lock ON/OFF signal S103 is output from the phase detection circuit 103 to the automatic discrimination circuit 107. The automatic discrimination circuit 107 determines whether or not the broadcast system of the input picture signal (Croma signal) coincides with that of the broadcast system determination device based on the burst lock ON/OFF signal S103. If it is determined that they coincide with each other, the position of the switch 108 is kept unchanged. If not, the automatic discrimination circuit 107 outputs a control signal to turn the switch 108 to the other side, thereby selecting the other crystal oscillator.

The method by which the automatic discrimination circuit 107 determines the broadcast system will now be described. For example, if the broadcast system of the input picture signal is the PAL system and the switch 108 is selecting the NTSC crystal oscillator 109, the APC circuit 111 is not burst-locked, whereby the burst lock ON/OFF signal S103 output from the phase detection circuit 103 indicates an OFF state. Therefore, the automatic discrimination circuit 107 determines that the broadcast system of the input picture signal does not coincide with that of the broadcast system determination device, and outputs a control signal to the switch 108 so that the other oscillator, i.e., the PAL crystal oscillator 110, is selected. Also if the broadcast system of the input picture signal is the NTSC system and the switch 108 is selecting the PAL crystal oscillator 110, the burst lock ON/OFF signal S103 indicates a lock OFF state. Therefore, the automatic discrimination circuit 107 determines that the broadcast system of the input picture signal does not coincide with that of the broadcast system determination device, and outputs a control signal to the switch 108 so that the other oscillator, i.e., the NTSC crystal oscillator 109, is selected.

Thus, where the circuit operation is performed in the NTSC system, if an NTSC signal is received, the signal is properly processed and a normal signal can be output to the outside. If a PAL signal is received, the lock comes off and the broadcast system is determined. Then, based on the determination result, the circuit operation is switched to the PAL system, whereby a normal signal can be output.

However, the conventional broadcast system determination device requires a long time for determining whether or not the APC circuit 111 is locked. Although a blue screen or a black screen is displayed so that no video image is displayed during a period in which the broadcast system is being determined, i.e., during a period in which an abnormal signal is being output, such a period being long lowers the grace of the product.

### SUMMARY OF THE INVENTION

An object of the present invention is to provide a burst frequency discrimination circuit capable of instantaneously determining the burst frequency of an input signal to determine the broadcast system of the input signal.

In order to achieve the object set forth above, the present invention focuses on the FM demodulation circuit included in the picture signal processing circuit, which can demodulate an input picture signal to obtain a frequency component. In the present invention, a demodulated frequency component signal obtained by the FM demodulation circuit is compared with a predetermined value to determine the burst frequency and to thereby determine whether the input signal is a PAL signal or an NTSC signal.

Specifically, the present invention provides a burst frequency discrimination circuit to which a single operating clock is input, including: a bandpass filter circuit for separating a chroma signal from an input picture signal; a line synchronizing separation circuit for separating a horizontal synchronizing signal from the input picture signal; a burst gate pulse generation circuit for generating a burst gate pulse based on the horizontal synchronizing signal separated by the line synchronizing separation circuit; an FM demodulation circuit for demodulating the chroma signal output from the bandpass filter circuit to obtain a frequency component; a SECAM color-difference demodulation circuit for demodulating the demodulated signal output from the FM demodulation circuit to obtain a SECAM color-difference signal; a burst extracting circuit for extracting a burst signal portion as a burst demodulated signal from the demodulated signal output from the FM demodulation circuit using the burst gate pulse output from the burst gate pulse generation circuit as a reference; and a comparison circuit for comparing the burst demodulated signal output from the burst extracting circuit with a predetermined value.

In one embodiment of the burst frequency discrimination circuit of the present invention, the FM demodulation circuit includes: a Hilbert conversion circuit for converting the chroma signal from the bandpass filter circuit to a signal whose phase is shifted by 90° with respect to that of the chroma signal; an arc tangent circuit for receiving an output from the Hilbert conversion circuit; a differentiation circuit for differentiating an output signal from the arc tangent circuit; and a deviation circuit for converting an output signal from the differentiation circuit to a signal having a predetermined mean frequency.

A burst frequency discrimination circuit of the present invention includes: a clock switching circuit for receiving a clock switching signal and switching an operating clock of the burst frequency discrimination circuit between a 17.7-MHz clock and a 14.3-MHz clock based on the received clock switching signal; a bandpass filter circuit for separating a chroma signal from an input picture signal; a line synchronizing separation circuit for separating a horizontal synchronizing signal from the input picture signal; a burst gate pulse generation circuit for generating a burst gate pulse based on the horizontal synchronizing signal separated by the line synchronizing separation circuit; a variable-type FM demodulation circuit for demodulating the chroma signal output from the bandpass filter circuit to obtain a frequency component, wherein a demodulation mean frequency can be varied by the clock switching signal in the demodulation process; a SECAM color-difference demodulation circuit for demodulating the demodulated signal output from the variable-type FM demodulation circuit to obtain a SECAM color-difference signal where the input picture signal is a SECAM signal; an NTSC/PAL color-difference demodulation circuit for demodulating the input picture signal where the input picture signal is an NTSC signal or a PAL signal; a burst extracting circuit for extracting a burst signal portion as a burst demodulated signal from the demodulated signal output from the variable-type FM demodulation circuit using the burst gate pulse output from the burst gate pulse generation circuit as a reference; and a comparison circuit for comparing the burst demodulated signal output from the burst extracting circuit with a predetermined value.

In one embodiment of the burst frequency discrimination circuit of the present invention, the line synchronizing separation circuit is of a rising-edge-detecting type, and separates a horizontal synchronizing signal from the input picture signal and detects a rising edge of the separated horizontal synchronizing signal; and the burst gate pulse generation circuit generates the burst gate pulse based on the rising edge of the horizontal synchronizing signal detected by the line synchronizing separation circuit.

In one embodiment of the burst frequency discrimination circuit of the present invention, the line synchronizing separation circuit and the burst gate pulse generation circuit operate using a fixed clock as an operating clock, the fixed clock being not switched from one to another by the clock switching signal input to the clock switching circuit.

A burst frequency discrimination circuit of the present invention includes: a clock switching circuit for receiving a clock switching signal and switching an operating clock of the burst frequency discrimination circuit between a 17.7-MHz clock and a 14.3-MHz clock based on the received clock switching signal; a bandpass filter circuit for separating a chroma signal from an input picture signal; a line synchronizing separation circuit for separating a horizontal synchronizing signal from the input picture signal; a pre-burst edge detection circuit for detecting a start position of a burst signal from the line synchronizing separation circuit to output a pre-burst edge detection signal; a trace-type burst gate pulse generation circuit for generating a burst gate pulse following a burst signal position using the pre-burst edge detection signal output from the pre-burst edge detection circuit as a reference; a variable-type FM demodulation circuit for demodulating the chroma signal output from the bandpass filter circuit to obtain a frequency component, wherein a demodulation mean frequency can be varied by the clock switching signal in the demodulation process; a SECAM color-difference demodulation circuit for demodulating the demodulated signal output from the variable-type FM demodulation circuit to obtain a SECAM color-difference signal; a burst extracting circuit for extracting a burst signal portion as a burst demodulated signal from the demodulated signal output from the variable-type FM demodulation circuit using the burst gate pulse output from the trace-type burst gate pulse generation circuit as a reference; and a comparison circuit for comparing the burst demodulated signal output from the burst extracting circuit with a predetermined value.

In one embodiment of the burst frequency discrimination circuit of the present invention, the burst frequency discrimination circuit further includes: an additional bandpass filter circuit, provided in addition to the bandpass filter circuit, for separating a broad-band chroma signal from the input picture signal; and a bandpass filter switching circuit for switching between the bandpass filter circuit and the additional bandpass filter circuit by using a clock switching signal.

In one embodiment of the burst frequency discrimination circuit of the present invention, the bandpass filter switching circuit selects the bandpass filter circuit when the clock switching circuit selects the 17.7-MHz clock and selects the additional bandpass filter circuit when the clock switching circuit selects the 14.3-MHz clock.

In one embodiment of the burst frequency discrimination circuit of the present invention, the variable-type FM demodulation circuit includes: a Hilbert conversion circuit for converting the chroma signal from the bandpass filter circuit to a signal whose phase is shifted by 90° with respect to that of the chroma signal; an arc tangent circuit for receiving an output from the Hilbert conversion circuit; a differentiation circuit for differentiating an output signal from the arc tangent circuit; and a mean-frequency-switching-type deviation circuit for, when the clock switching circuit selects the 14.3-MHz clock, variably setting the demodulation mean frequency so that the demodulation mean frequency is lowered as compared with a case where the 17.7-MHz clock is selected, and converting an output signal from the differentiation circuit to a signal of the variably-set demodulation mean frequency.

As described above, a burst frequency discrimination circuit of the present invention uses the line synchronizing separation circuit, the burst gate pulse generation circuit and the burst extracting circuit to obtain a demodulated signal of a burst signal portion of the input signal, and the demodulated signal is compared with a predetermined value by the comparison circuit, the result of which is output as the burst frequency discrimination signal. Therefore, unlike in the prior art, it is not necessary to determine whether or not the clock is locked to the burst signal, and it is possible to instantaneously determine, based on the output burst frequency discrimination signal, whether the input signal is an NTSC signal or a PAL signal to appropriately change the settings of the product. Moreover, the bandpass filter circuit and the FM demodulation circuit can be used also as a portion of the circuit having the SECAM color demodulation function, whereby the circuit scale can be reduced.

Moreover, in the burst frequency discrimination circuit of the present invention, an operating clock of 17.7 MHz for processing a PAL signal or an operating clock of 14.3 MHz for processing an NTSC signal is selected based on clock switching signal. The picture signal processing circuit including the burst frequency discrimination circuit is operated by using the selected clock, and the burst gate pulse signal is generated by the burst gate pulse generation circuit using the horizontal synchronizing signal output from the line synchronizing separation circuit as a reference. Furthermore, the demodulated signal of the burst signal portion of the input picture signal is extracted by the burst extracting circuit, and the demodulated signal is compared with a predetermined value by the comparison circuit, the result of which is output as the burst frequency discrimination signal. Therefore, it is possible to instantaneously output a burst frequency discrimination signal without an erroneous determination even if noise is contained. Moreover, a single NTSC/PAL color-difference demodulation circuit can be commonly used for demodulating an NTSC color signal and a PAL color signal by switching the operating clock from one to another, whereby the circuit scale can be further reduced.

Particularly, according to the present invention, the burst gate pulse generation circuit generates the burst gate pulse signal using the rising edge signal of the horizontal synchronizing signal output from the rising-edge-detecting-type line synchronizing separation circuit as a reference, whereby it is possible to accurately extract the burst signal portion even if the operating clock is switched from one to another.

Moreover, with the burst frequency discrimination circuit of the present invention, the line synchronizing separation circuit and the burst gate pulse generation circuit are operated by using a fixed clock that is not switched from one to another by the clock switching signal, whereby the burst extracting circuit can accurately extract the burst signal portion even if the input picture signal is switched between an NTSC signal and a PAL signal. Then, the demodulated signal of the burst signal portion output from the burst extracting circuit is compared with a predetermined value by the comparison circuit, the result of which is output as the burst frequency discrimination signal. Therefore, it is possible to output a burst frequency discrimination signal with an even higher precision without an erroneous determination even if noise is contained.

In addition, in the burst frequency discrimination circuit of the present invention, the line synchronizing separation circuit detects the horizontal synchronizing signal from the input picture signal, and the pre-burst edge detection circuit outputs the pre-burst edge detection signal using the detected horizontal synchronizing signal as a reference, thus detecting the start position of the burst signal. The input picture signal is also demodulated by the FM demodulation circuit, and the trace-type burst gate pulse generation circuit generates the burst gate pulse signal starting from a start position of the burst signal portion that is determined as a position at which the demodulated signal becomes greater than a predetermined value during the period in which the pre-burst edge detection signal is high. Furthermore, the burst extracting circuit extracts the burst signal portion even more accurately from the demodulated signal output from the FM demodulation circuit, and the demodulated signal of the burst signal portion is compared with a predetermined value by the comparison circuit, the result of which is output as the burst frequency discrimination signal. Therefore, it is possible to instantaneously output a burst frequency discrimination signal with a high precision without an erroneous determination even if noise is contained and even if there is a shift in the position at which the burst signal is superimposed such as in a signal reproduced from a VCR.

Furthermore, the burst frequency discrimination circuit of the present invention includes, in addition to the bandpass filter circuit for separating a chroma signal from an input picture signal, the additional bandpass filter circuit for separating a broad-band chroma signal, wherein the normal bandpass filter circuit is selected when the operating clock is switched to 17.7 MHz by the clock switching signal, while the additional broad-band bandpass filter circuit is selected when the operating clock is 14.3 MHz, whereby a demodulation operation is performed by the FM demodulation circuit without attenuating the frequency component of the burst signal through the bandpass filter circuit section. Using the burst gate pulse signal output from the trace-type burst gate pulse generation circuit, the burst extracting circuit extracts the burst signal portion, and the demodulated signal of the burst signal portion is compared with a predetermined value by the comparison circuit, the result of which is output as the burst frequency discrimination signal. Therefore, it is possible to instantaneously determine the burst frequency and output a burst frequency discrimination signal with a high precision even if the input picture signal has a low amplitude or a shifted burst position.

### BRIEF DESCRIPTION OF THE DRAWINGS

FIG. 1 shows a configuration of a picture signal processing circuit including a burst frequency discrimination circuit according to a first embodiment of the present invention.

FIG. 2 shows a configuration of a picture signal processing circuit including a burst frequency discrimination circuit according to a second embodiment of the present invention.

FIG. 3 shows a configuration of a picture signal processing circuit including a burst frequency discrimination circuit according to a third embodiment of the present invention.

FIG. 4 shows a configuration of a picture signal processing circuit including a burst frequency discrimination circuit according to a fourth embodiment of the present invention.

FIG. 5 shows a configuration of a picture signal processing circuit including a burst frequency discrimination circuit according to a fifth embodiment of the present invention.

FIG. 6 shows a configuration of a conventional broadcast system determination device.

FIG. 7A to FIG. 7D2 show waveforms of output signals from various internal circuits in the picture signal processing circuit of the first embodiment, where a SECAM signal is processed.

FIG. 8A to FIG. 8G2 show waveforms of output signals from various internal circuits in the burst frequency discrimination circuit of the first embodiment.

FIG. 9A to FIG. 9D2 show waveforms of output signals from various internal circuits in the burst frequency discrimination circuit of the second embodiment, where the falling edge of a line synchronizing separation circuit is used as a reference.

FIG. 10A to FIG. 10D2 show waveforms of output signals from various internal circuits in the burst frequency discrimination circuit of the second embodiment, where the rising edge of a line synchronizing separation circuit is used as a reference.

FIG. 11A to FIG. 11F show waveforms of output signals from various internal circuits in the burst frequency discrimination circuit of the third embodiment.

### DESCRIPTION OF THE PREFERRED EMBODIMENTS

Preferred embodiments of the present invention will now be described with reference to the drawings.

### First Embodiment

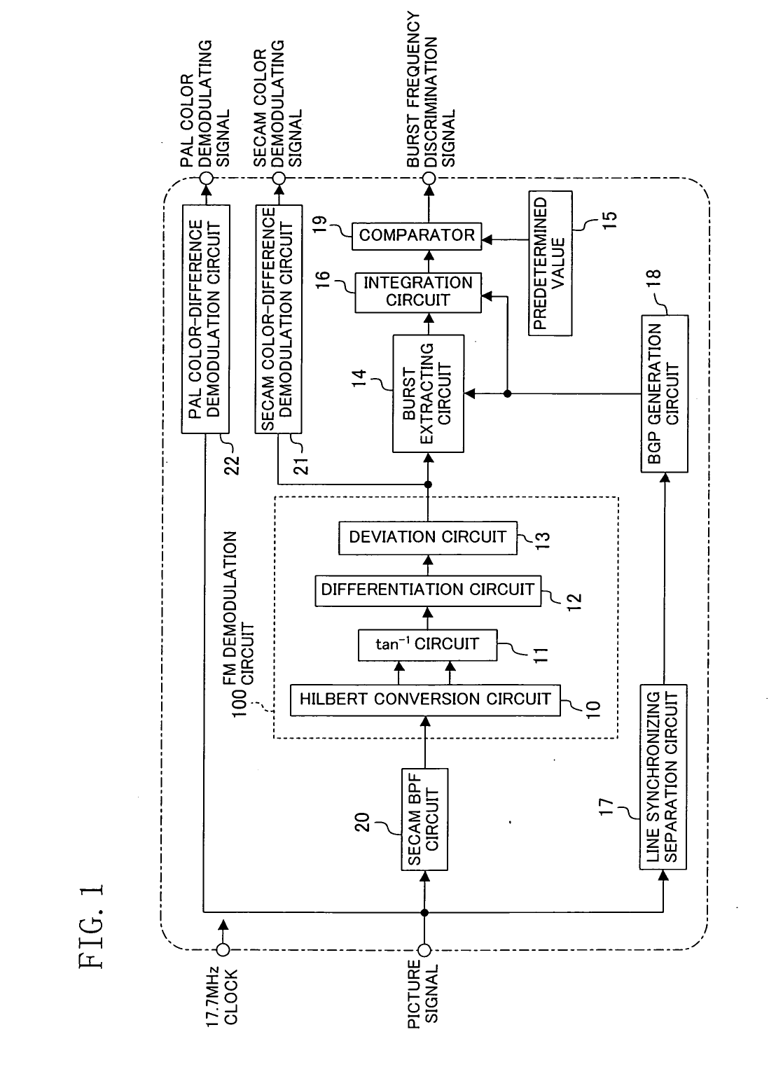

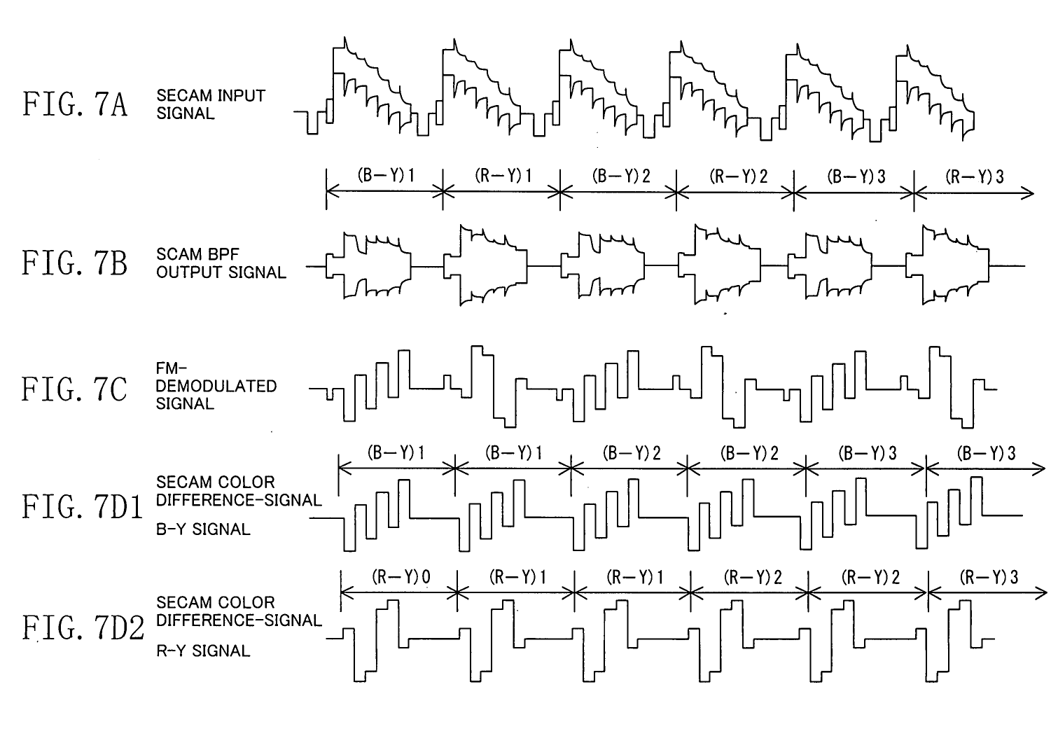

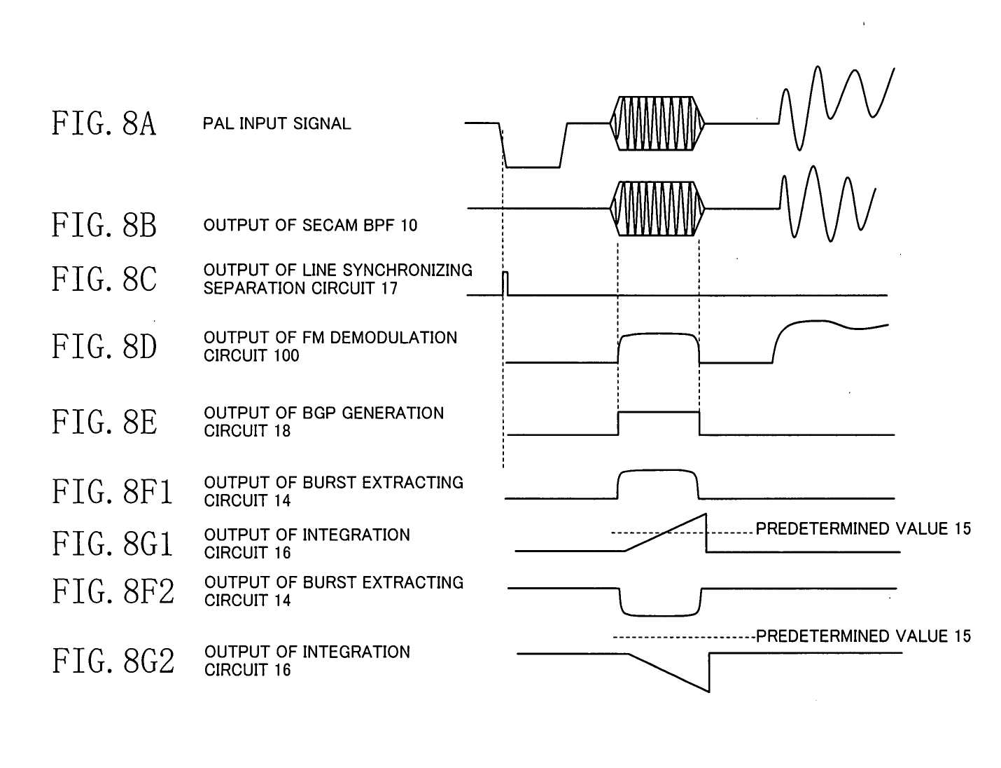

FIG. 1, FIG. 7A to FIG. 7D2 and FIG. 8A to FIG. 8G2 show a burst frequency discrimination circuit according to a first embodiment of the present invention.

FIG. 1 shows a configuration of a picture signal processing circuit including the burst frequency discrimination circuit of the present embodiment.

Referring to FIG. 1, the burst frequency discrimination circuit of the present embodiment includes a SECAM bandpass filter (SECAM BPF) circuit 20, a burst extracting circuit 14, an FM demodulation circuit 100, an integration circuit 16, a predetermined value 15, a comparator (comparison circuit) 19, a SECAM color-difference demodulation circuit 21, a PAL color-difference demodulation circuit 22, a line synchronizing separation circuit 17 and a BGP (burst gate pulse) generation circuit 18. The FM demodulation circuit 100 includes a Hilbert conversion circuit 10, an arc tangent circuit 11, a differentiation circuit 12 and a deviation circuit 13.

The configuration and the operation of the burst frequency discrimination circuit of the present embodiment as described above will now be described in detail with reference to FIG. 7A to FIG. 7D2 and FIG. 8A to FIG. 8G2.

Where SECAM Signal is Received

FIG. 7A to FIG. 7D2 show signal waveforms at different positions, where a SECAM signal is input to the burst frequency discrimination circuit of the present embodiment.

First, a case where a SECAM signal is input to the burst frequency discrimination circuit of the present embodiment will be described with reference to FIG. 7A to FIG. 7D2. The SECAM color television broadcasting, which is primarily used in some regions of Europe and in the Middle and Near East, differs from the NTSC system and the PAL system particularly in the color modulation scheme. Amplitude modulation is used in the NTSC system and the PAL system, whereas frequency modulation is used in the SECAM system. Specifically, the R-Y signal is frequency-modulated with a carrier frequency of 4.40625 MHz and the B-Y signal is frequency-modulated with a carrier frequency of 4.25 MHz, and the R-Y signal and the B-Y signal are alternately transmitted from one horizontal period to another (i.e., in a line-sequential system). The SECAM system uses the same luminance signal as that of the PAL system, and in many cases uses a clock signal of 17.7 MHz, which is commonly used in the PAL system, for processing a SECAM signal. The burst frequency discrimination circuit of the present embodiment also uses a clock signal of 17.7 MHz.

An input SECAM signal as shown in FIG. 7A is filtered through the SECAM BPF circuit 20, where the chroma component thereof is separated, and a signal as shown in FIG. 7B is output. Then, the chroma signal output from the SECAM BPF circuit 20 is frequency-demodulated through the FM demodulation circuit 100, and a demodulated signal as shown in FIG. 7C is input to the SECAM color-difference demodulation circuit 21. The SECAM color-difference demodulation circuit 21 performs a correction operation using different carrier frequencies for the R-Y signal and for the B-Y signal while separating the R-Y signal and the B-Y signal, which are combined together in a line-sequential manner, thereby outputting SECAM color-difference signals as shown in FIG. 7D1 and FIG. 7D2.

The FM demodulation circuit 100 operates as follows. The received output signal X(t) from the SECAM BPF circuit 20
X(t)=Asin ωt (S1)
is converted through the Hilbert conversion circuit 10 into a signal Y(t) whose phase is shifted by 90°
Y(t)=Acos ωt (S2).
These signals are passed to the arc tangent circuit 11, which outputs ωt based on an expression as shown below.

$${tan}^{- 1} ( \frac{X ( t )}{Y ( t )} ) = {tan}^{- 1} ( \frac{A sin ω t}{A cos ω t} ) = ω t \qquad ( S3 )$$

Then, the differentiation circuit 12 obtains ω. Thus, the FM demodulation circuit 100 can obtain the frequency of the signal output from the SECAM BPF circuit 20.

Then, the deviation circuit 13 converts the obtained signal into, for example, a signal whose mean frequency is 4.33 MHz being in the middle between 4.25 MHz and 4.40625 MHz, which are carrier frequencies of the SECAM color signal.

Thus, where a SECAM picture signal is received, the picture signal processing circuit including the burst frequency discrimination circuit of the present embodiment can serve as a SECAM color demodulation circuit to output a SECAM color-difference signal.

Where PAL Signal is Received

Next, a case where a PAL signal is input to the burst frequency discrimination circuit of the present embodiment will be described with reference to FIG. 8A to FIG. 8G2. A PAL signal is amplitude-modulated as described above, and is demodulated by the PAL color-difference demodulation circuit 22. Therefore, the SECAM BPF circuit 20 and the FM demodulation circuit 100, which are used for processing a SECAM signal, will be unused. Thus, where a PAL signal is received, the SECAM BPF circuit 20 and the FM demodulation circuit 100 can be used for a burst frequency discrimination process.

FIG. 8A to FIG. 8G2 show signal waveforms at different positions, particularly the burst signal portion, where a PAL signal is input to the burst frequency discrimination circuit of the present embodiment.

An input PAL signal as shown in FIG. 8A is filtered through the SECAM BPF circuit 20, where the chroma signal component thereof is separated (FIG. 8B). The line synchronizing separation circuit 17 separates the horizontal synchronizing signal of the input picture signal and detects the falling edge thereof (FIG. 8C). The FM demodulation circuit 100 performs the same operation as that for a SECAM signal to output the chroma signal frequency component. The FM demodulation circuit 100 converts the received signal into a signal whose mean frequency is 4.33 MHz, as described above. Since the burst frequency of a PAL signal is 4.43 MHz, the burst signal portion output from the FM demodulation circuit 100 will have a value greater than the center value (FIG. 8D).

The BGP generation circuit 18 generates a burst gate pulse (BGP) for extracting the burst signal portion using the falling edge position of the horizontal synchronizing signal as a reference (FIG. 8E). The burst extracting circuit 14 extracts only the burst signal portion from the demodulated signal output from the FM demodulation circuit 100 (FIG. 8F1) during a period in which the burst gate pulse signal is high, and the integration circuit 16 integrates the extracted signal over the period in which the burst gate pulse signal is high (FIG. 8G1). The comparison circuit 19 compares the output signal from the integration circuit 16 with the predetermined value 15 to output the comparison result as a burst frequency discrimination signal. A PAL signal has a burst frequency of 4.43 MHz, and the burst frequency discrimination signal will be a high signal.

Where NTSC Signal is Received

Next, a case where an NTSC signal is input to the burst frequency discrimination circuit of the present embodiment will be described. In the NTSC system, the burst frequency is 3.58 MHz. Therefore, the signal obtained by extracting only the burst signal portion from the demodulated signal output from the FM demodulation circuit 100 will have a value less than 4.33 MHz being the center value (FIG. 8F2). A signal obtained through integration by the integration circuit 16 will have a value less than the predetermined value 15. Therefore, the burst frequency discrimination signal output from the comparison circuit 19 will be a low signal.

As described above, the burst frequency discrimination circuit of the present embodiment includes the SECAM BPF circuit 20 and the FM demodulation circuit 100, and uses the line synchronizing separation circuit 17, the BGP generation circuit 18 and the burst extracting circuit 14 to obtain a demodulated signal of the burst signal portion of the input signal, which is passed through the integration circuit 16 and the comparator 19, where it is compared with the predetermined value 15, and the comparison result is output as the burst frequency discrimination signal. Thus, without requiring a determination as to whether or not the clock is locked to the burst signal, it is possible to instantaneously determine whether the broadcast system of the input signal is the NTSC system or the PAL system based on the burst frequency discrimination signal, according to which the settings of the product can be changed appropriately. Moreover, since FM demodulation is typically more tolerant of noise, the burst frequency discrimination circuit of the present embodiment is unlikely to make an erroneous determination.

Furthermore, in the burst frequency discrimination circuit of the present embodiment, the SECAM BPF circuit 20 and the FM demodulation circuit 100 are also used as a portion of the circuit having the SECAM color demodulation function, whereby the circuit scale can be reduced.

### Second Embodiment

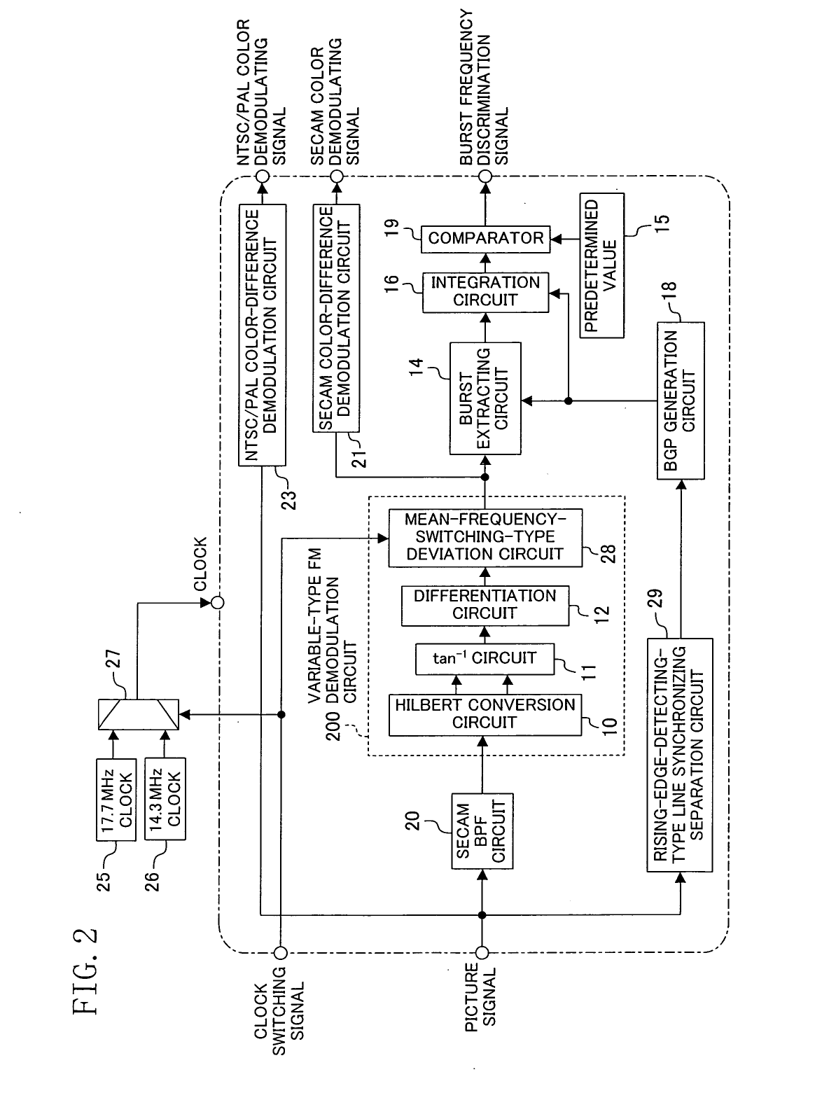

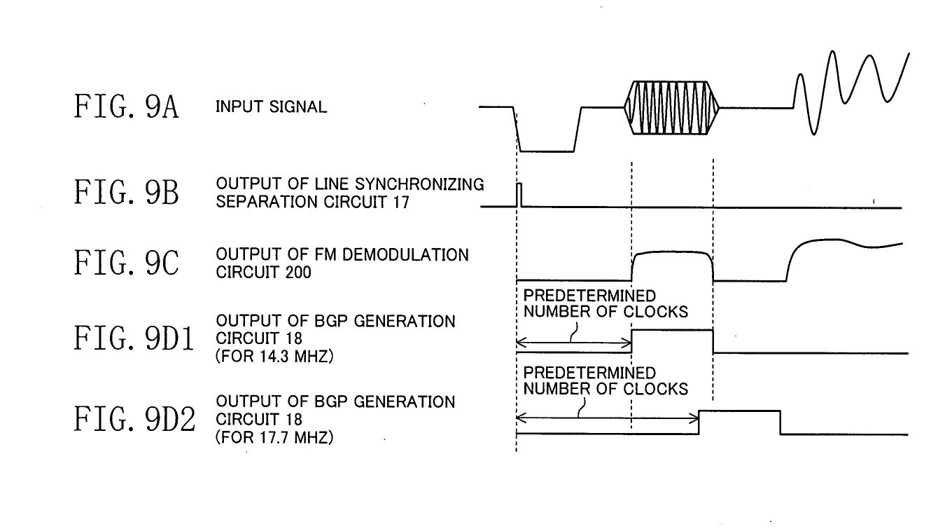

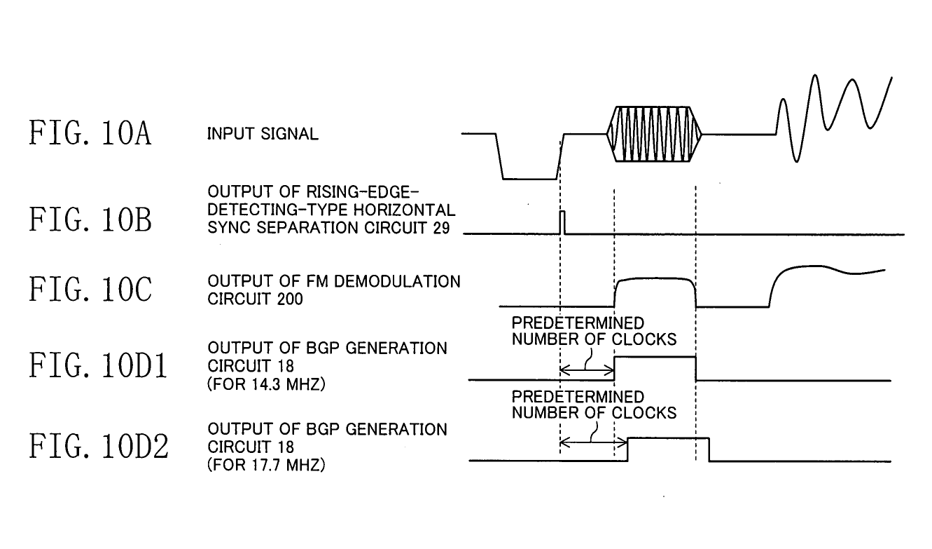

Next, a burst frequency discrimination circuit according to a second embodiment of the present invention will be described with reference to FIG. 2, FIG. 9A to FIG. 9D2 and FIG. 10A to FIG. 10D2.

FIG. 2 shows a configuration of a picture signal processing circuit including the burst frequency discrimination circuit of the present embodiment, and FIG. 9A to FIG. 9D2 and FIG. 10A to FIG. 10D2 show signal waveforms at different positions, where an NTSC signal or a PAL signal is input to the burst frequency discrimination circuit of the present embodiment.

Referring to FIG. 2, the burst frequency discrimination circuit of the present embodiment includes the SECAM BPF circuit 20, the burst extracting circuit 14, an FM demodulation circuit 200, the integration circuit 16, the predetermined value 15, the comparator 19, the SECAM color-difference demodulation circuit 21, an NTSC/PAL color-difference demodulation circuit 23, a rising-edge-detecting-type line synchronizing separation circuit 29, the burst gate pulse (BGP) generation circuit 18, a 17.7 MHz clock generation circuit 25, a 14.3 MHz clock generation circuit 26 and a clock selection circuit 27. The FM demodulation circuit 200 includes the Hilbert conversion circuit 10, the arc tangent circuit 11, the differentiation circuit 12 and a mean-frequency-switching deviation circuit 28. Like elements to those of the first embodiment will be denoted by like reference numerals, and will not be further described below.

It is commonly known that when an NTSC chroma signal and a PAL chroma signal are demodulated into color-difference signals, the NTSC signal is processed at 14.3 MHz and the PAL signal is processed at 17.7 MHz, as described above, and the process in the PAL system requires a phase alternating operation. However, the other demodulation circuits used for obtaining a color-difference signal can be shared between the NTSC system and the PAL system by only switching the operating clock from one to another.

Referring to FIG. 2, the clock switching signal is controlled according to the output burst frequency discrimination signal. When the burst frequency discrimination signal is high, the broadcast system of the input signal is determined to be the PAL system, and the clock selection circuit 27 selects the clock signal from the 17.7 MHz clock generation circuit 25. When the burst frequency discrimination signal is low, the broadcast system of the input signal is determined to be the NTSC system, and the clock selection circuit 27 selects the clock signal from the 14.3 MHz clock generation circuit 26. The picture signal processing circuit including the burst frequency discrimination circuit is operated with the selected clock signal.

Where the same line synchronizing separation circuit 17 as that of the first embodiment is used as the line synchronizing separation circuit, the BGP generation circuit 18 outputs a BGP signal at a position reached after counting a predetermined number of operating clock signals starting from the falling edge of the horizontal synchronizing signal output from the line synchronizing separation circuit 17, e.g., a position reached after counting 17.7 MHz×80 clocks where the operating clock is 17.7 MHz, or a position reached after counting 14.3 MHz×80 clocks where the operating clock is 14.3 MHz. Thus, the BGP signal will be output at a position as shown in FIG. 9D1 and at a position as shown in FIG. 9D2. While the timing of the BGP signal as shown in FIG. 9D1 coincides with that of the burst signal portion output from the FM demodulation circuit 200, the timing of the BGP signal as shown in FIG. 9D2 does not coincide with that of the burst signal portion.

In view of this, the burst frequency discrimination circuit of the present embodiment uses the rising-edge-detecting-type line synchronizing separation circuit 29. Since the amount of time from the rising edge of the horizontal synchronizing signal to the burst signal is short, the timing of the BGP signal and that of the burst signal portion will not be substantially shifted from each other even when the operating clock is switched from one to another, as shown in FIG. 10D1 and FIG. 10D2. An insubstantial shift will cause no problem as it is absorbed by the integration circuit 16.

Next, the FM demodulation circuit 200 will be described. The signal input to the FM demodulation circuit 200 is expressed as shown below.

$$Y ( n \cdot T ) = A sin [ 2 π \{ {\sum }_{i = 0}^{n - 1} ( \frac{{f}_{0}}{{f}_{s}} + \frac{{D}_{f}}{{f}_{s}} \cdot X ( i \cdot T ) ) \} ] \qquad S ( 4 )$$

In Expression S(4), f0 is the frequency shift, fs is the sampling frequency, Df is the deviation frequency, X(i·T) is the modulated signal at the i^{th} point. This signal is processed through the Hilbert conversion circuit 10, the arc tangent circuit 11 and the differentiation circuit 12 to yield the following signal.

$$Y = \frac{{f}_{c}}{{f}_{s}} + \frac{{D}_{f}}{{f}_{s}} \cdot X \qquad S ( 5 )$$

Where a SECAM signal is processed, if the operating clock is 17.7 MHz, the mean frequency is set to 4.33 MHz as described above. With this circuit, if only the operating clock is switched to 14.3 MHz, the mean frequency will be as shown in the expression below.

$$4.43 \times \frac{14.3 MHz}{17.7 MHz} = 3.50 MHz \qquad S ( 6 )$$

Thus, when the operating clock is switched to 14.3 MHz, either an input NTSC signal whose burst frequency is 3.58 MHz or an input PAL signal whose burst frequency is 4.43 MHz will result in a frequency greater than 3.5 MHz being the mean frequency, thus failing to normally detect the burst frequency.

In view of this, the burst frequency discrimination circuit of the present embodiment uses the mean-frequency-switching deviation circuit 28, whereby the mean frequency is switched to 4.0 MHz being in the middle between 3.58 MHz and 4.43 MHz, for example, when the operating clock is switched to 14.3 MHz by a clock switching signal.

As described above, with the burst frequency discrimination circuit of the present embodiment, the operating clock is switched between 17.7 MHz and 14.3 MHz with the clock switching signal, and the picture signal processing circuit including the burst frequency discrimination circuit is operated using the clock signal. Moreover, the BGP signal is generated by the BGP generation circuit 18 by using the rising edge signal of the horizontal synchronizing signal output from the rising-edge-detecting-type line synchronizing separation circuit 29 as a reference. Furthermore, a demodulated signal of the burst signal portion of the input signal is extracted by the burst extracting circuit 14, and the demodulated signal of the burst signal portion is integrated by the integration circuit 16, after which the value of the obtained signal is compared with the predetermined value 15 by the comparator 19, the result of which is output as the burst frequency discrimination signal. Therefore, it is possible to instantaneously output a burst frequency discrimination signal without an erroneous determination. Moreover, the NTSC/PAL color-difference demodulation circuit 23 can be used commonly for demodulating an NTSC color signal and a PAL color signal by switching the operating clock from one to another, whereby the circuit scale can be further reduced.

### Third Embodiment

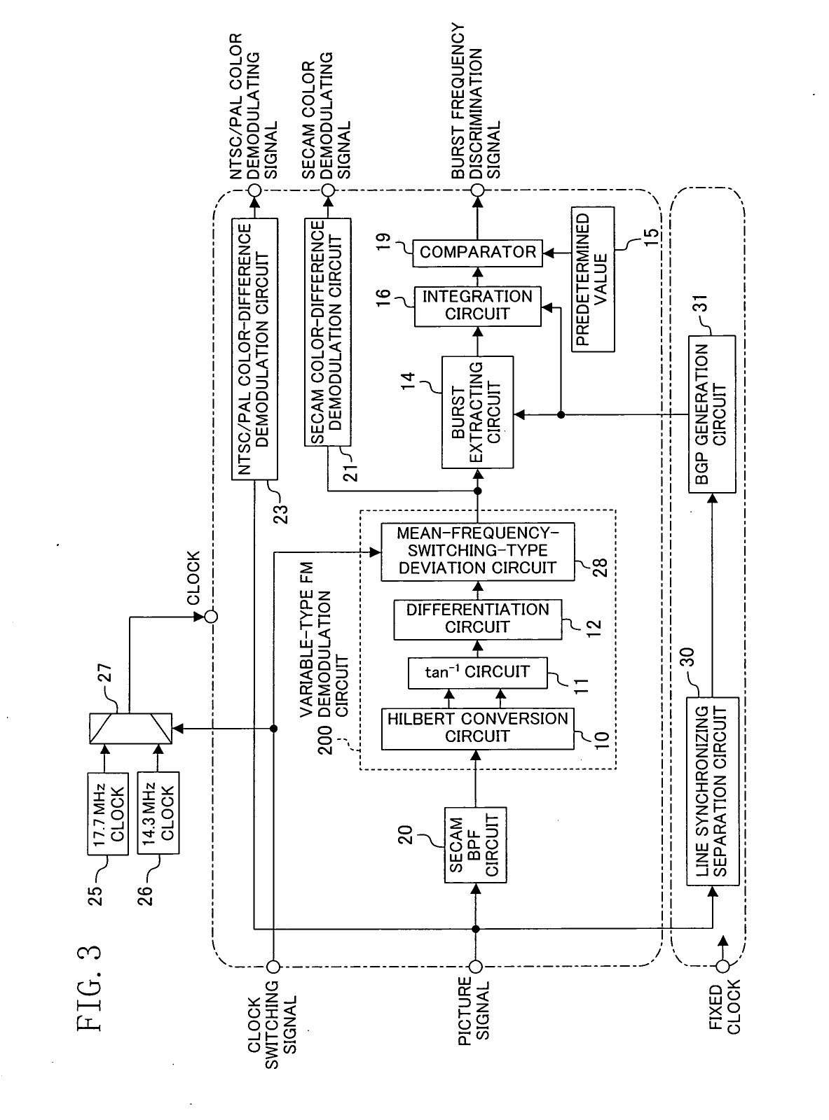

A burst frequency discrimination circuit according to a third embodiment of the present invention will now be described with reference to FIG. 3.

FIG. 3 shows a configuration of a picture signal processing circuit including the burst frequency discrimination circuit of the present embodiment. Referring to FIG. 3, the burst frequency discrimination circuit of the present embodiment includes a line synchronizing separation circuit 30 and a BGP generation circuit 31 operating at a fixed clock.

Other than this, the configuration is the same as that of the burst frequency discrimination circuit of the second embodiment. Therefore, like elements to those of the second embodiment will be denoted by like reference numerals, and will not be further described below.

In the line synchronizing separation circuit 30 for separating a horizontal synchronizing signal and generating the horizontal synchronizing signal as a reference signal, the falling edge of the horizontal synchronizing signal is used as a reference as described above in some cases and the rising edge is used as a reference in others. The burst signal is present near the rising edge of the horizontal synchronizing signal, and noise is likely to be introduced in the rising edge due to attenuation of the burst signal, a shift in the signal position thereof, etc. In view of this, the falling edge is often used.

Referring to FIG. 3, the fixed clock is a clock signal that is not switched by the clock switching signal but is fixed at 27 MHz, for example. The input picture signal is passed to the line synchronizing separation circuit 30 operating at the fixed clock, and the line synchronizing separation circuit 30 outputs the falling edge signal of the horizontal synchronizing signal. The BGP generation circuit 31 outputs a BGP signal at a position reached after counting a predetermined number of clock signals starting from the falling edge. The amount of time from the falling edge of the horizontal synchronizing signal to the start position of the burst signal is substantially the same between an NTSC signal and a PAL signal. Therefore, by operating the line synchronizing separation circuit 30 and the BGP generation circuit 31 at the fixed clock, the BGP signal output from the BGP generation circuit 31 will overlap the burst signal portion of the input signal, irrespective of whether the input signal is an NTSC signal or a PAL signal. Thus, it is possible with the burst extracting circuit 14 to accurately extract the burst signal portion from the demodulated signal output from the FM demodulation circuit 200, and the result of a comparison with the predetermined value 15 by the integration circuit 16 and the comparator 19 can be output as the burst frequency discrimination signal.

As described above, with the burst frequency discrimination circuit of the present embodiment, the line synchronizing separation circuit 30 and the BGP generation circuit 31 are operated with a fixed clock that is not switched to another by the clock switching signal, whereby it is possible with the burst extracting circuit 14 to accurately extract the burst signal portion even if the input clock signal is switched to another. Then, the demodulated signal of the burst signal portion output from the burst extracting circuit 14 is integrated by the integration circuit 16 and compared with the predetermined value 15 by the comparator 19, the result of which is output as the burst frequency discrimination signal. Therefore, it is possible to instantaneously output a burst frequency discrimination signal with an even higher precision without an erroneous determination even if noise is contained.

### Fourth Embodiment

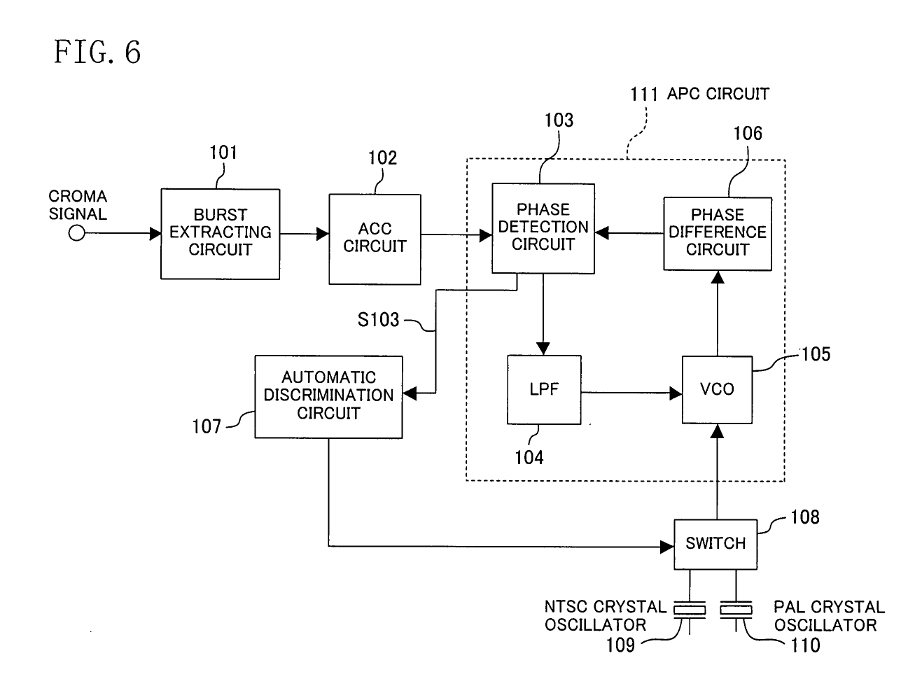

A burst frequency discrimination circuit according to a fourth embodiment of the present invention will now be described with reference to FIG. 4 and FIG. 1A to FIG. 11F.

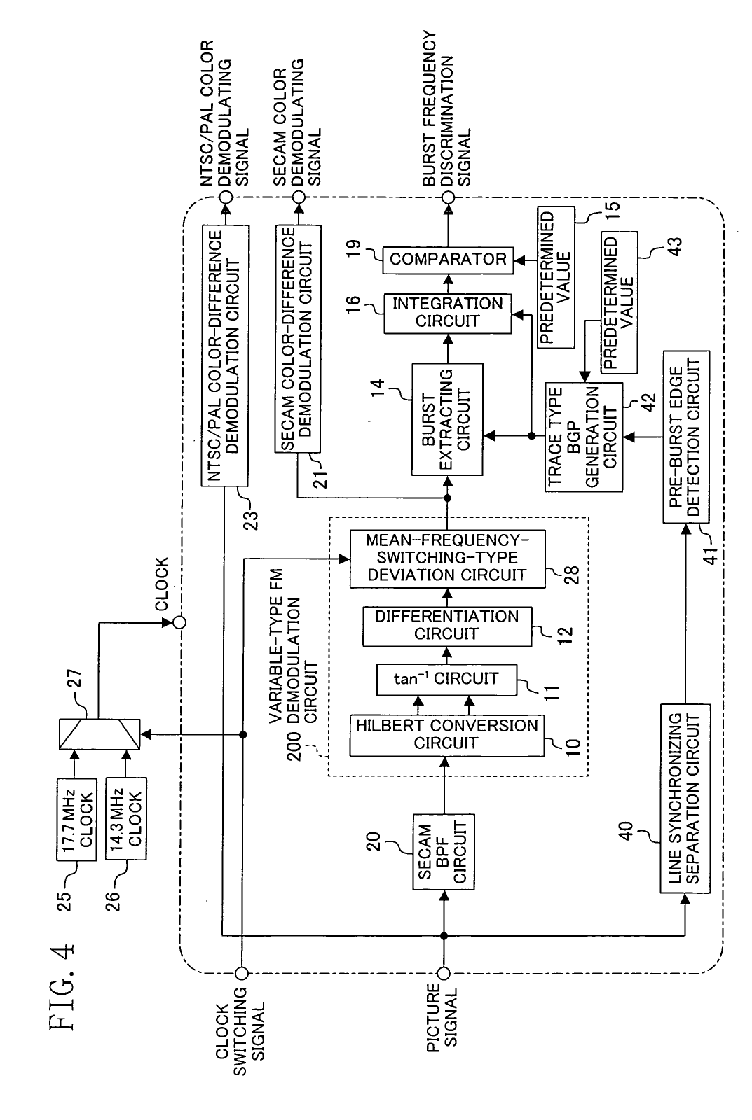

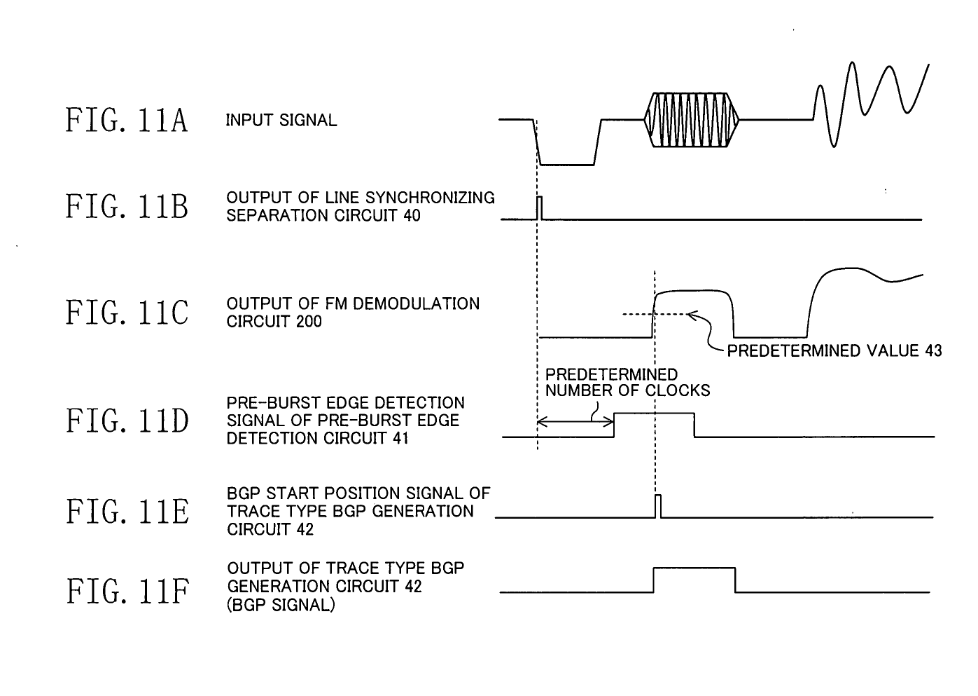

FIG. 4 shows a configuration of a picture signal processing circuit including the burst frequency discrimination circuit of the present embodiment, and FIG. 11A to FIG. 11F show signal waveforms at different positions used for illustrating the operation of a pre-burst edge detection circuit 41 and a trace-type BGP generation circuit 42, which will be described later.

Referring to FIG. 4, the burst frequency discrimination circuit of the present embodiment includes a line synchronizing separation circuit 40, the pre-burst edge detection circuit 41, the trace-type BGP generation circuit 42 and a predetermined value 43. Other than this, the configuration is the same as that of the burst frequency discrimination circuit of the second embodiment. Therefore, like elements to those of the second embodiment will be denoted by like reference numerals, and will not be further described below.

An input picture signal is filtered through the SECAM BPF circuit 20, where the chroma signal thereof is separated, and frequency-demodulated by the FM demodulation circuit 200 whose demodulation mean frequency is switched from one to another by a clock switching signal. The input picture signal is also passed to the line synchronizing separation circuit 40, where the falling edge portion thereof is detected (FIG. 11B). Based on the falling edge signal output from the line synchronizing separation circuit 40, the pre-burst edge detection circuit 41 outputs a signal that transitions to a high level over a predetermined period of time after the passage of a predetermined period of time, as shown in FIG. 11D. The trace-type BGP generation circuit 42 calculates a position at which the demodulated signal output from the FM demodulation circuit 200 becomes greater than the predetermined value 43 during the period in which the pre-burst edge detection signal is high. This position is the burst signal start position of the input picture signal (FIG. 11E). Moreover, the trace-type BGP generation circuit 42 outputs a BGP signal with the burst signal start position being a reference.

In a picture signal, particularly a signal reproduced from a VCR, or the like, the position of the superimposed burst signal is often shifted forward or backward from the position as specified in the NTSC or PAL standard. With the trace-type BGP generation circuit 42, even if a burst signal is shifted from the position as specified in a standard, it is possible to detect the burst signal and output a BGP signal while following the shifting burst signal.

The burst extracting circuit 14 even more accurately extracts the burst signal portion from the demodulated signal output from the FM demodulation circuit 200, and the modulated signal of the burst signal portion is integrated by the integration circuit 16 and compared with the predetermined value 15 by the comparator 19, the result of which is output as the burst frequency discrimination signal.

As described above, with the burst frequency discrimination circuit of the present embodiment, the line synchronizing separation circuit 40 detects the falling edge of the horizontal synchronizing signal from an input picture signal, and the pre-burst edge detection circuit 41 outputs the pre-burst edge detection signal with the falling edge signal being the reference, thereby detecting the start position of the burst signal. Moreover, the input picture signal is demodulated by the FM demodulation circuit 200, and the trace-type BGP generation circuit 42 generates the BGP signal at the start position of the burst signal portion, which is obtained as a position at which the demodulated signal becomes greater than the predetermined value 43 during the period in which the pre-burst edge detection signal is high. Moreover, the burst extracting circuit 14 even more accurately extracts the burst signal portion from the demodulated signal output from the FM demodulation circuit 200, and the modulated signal of the burst signal portion is integrated by the integration circuit 16 and compared with the predetermined value 15 by the comparator 19, the result of which is output as the burst frequency discrimination signal. Therefore, it is possible to instantaneously output a burst frequency discrimination signal with a high precision without an erroneous determination even if noise is contained and even if there is a shift in the position at which the burst signal is superimposed such as in a signal reproduced from a VCR.

### Fifth Embodiment

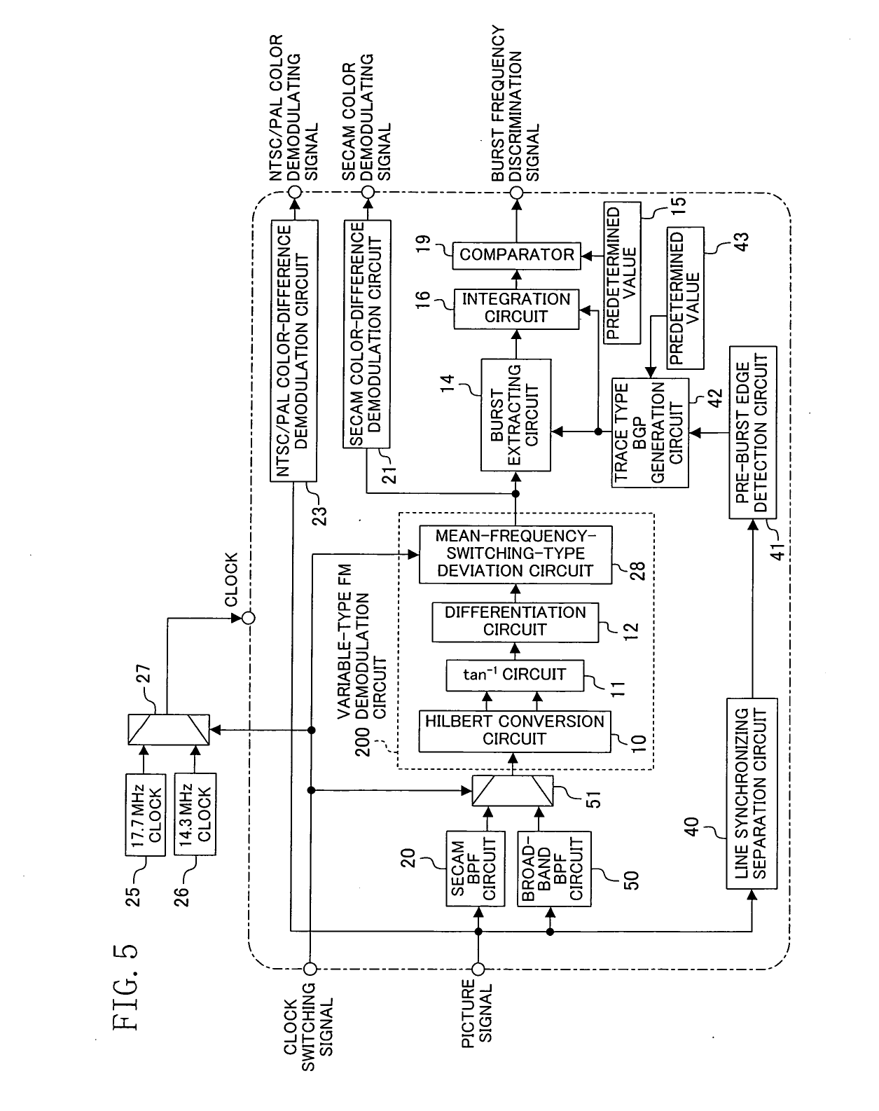

A burst frequency discrimination circuit according to a fifth embodiment of the present invention will now be described with reference to FIG. 5.

FIG. 5 shows a configuration of a picture signal processing circuit including the burst frequency discrimination circuit of the present embodiment. Referring to FIG. 5, the burst frequency discrimination circuit of the present embodiment includes the SECAM BPF circuit 20, a broad-band BPF circuit (another bandpass filter) 50, and a BPF selection circuit 51 for selecting one of the output signal from the SECAM BPF circuit 20 and the output signal from the broad-band BPF circuit 50 based on the clock switching signal. Other than this, the configuration is the same as that of the burst frequency discrimination circuit of the second embodiment. Therefore, like elements to those of the second embodiment will be denoted by like reference numerals, and will not be further described below.

The SECAM BPF circuit 20 is a bandpass filter for separating a chroma signal from a SECAM signal. The band of a chroma signal superimposed on a SECAM signal is 3.9 MHz to 4.75 MHz, and the SECAM BPF circuit 20 is a filter having frequency characteristics suitable for separating this band.

Where the input picture signal is a PAL signal, 17.7 MHz is selected by the clock switching signal, which is the same frequency as that when a SECAM signal is input. Therefore, as in a case where a SECAM signal is processed, the SECAM BPF circuit 20 functions as a bandpass filter whose passband is 3.9 MHz to 4.75 MHz, through which the burst signal of the PAL system having a frequency of 4.43 MHz can pass.

If an NTSC signal is input, whose burst signal frequency is 3.58 MHz, the amplitude thereof is attenuated through the SECAM BPF circuit 20. Particularly, if the amplitude of the input NTSC signal is very small, the SECAM BPF circuit 20 may attenuate the amplitude to remove the amplitude component thereof so that the signal is out of the demodulation range of the FM demodulation circuit 200, in which case the demodulated signal output from the FM demodulation circuit 200 may have a frequency close to 0 MHz. In such a case, however, the mean frequency is 4.33 MHz, as described above, whereby even if the frequency of the demodulated signal is 0 MHz, being less than 3.58 MHz, the burst frequency discrimination signal output from the burst frequency discrimination circuit exhibits a normal value.

Where the input picture signal is an NTSC signal, 14.3 MHz is selected by the clock switching signal. Then, since the operating clock of the SECAM BPF circuit 20 is also 14.3 MHz, the frequency characteristics change to such characteristics that 3.8 MHz is separated from 3.15 MHz. If a PAL signal is input whose signal amplitude is very small, the SECAM BPF circuit 20 may attenuate the amplitude to remove the amplitude component thereof so that the signal is out of the demodulation range of the FM demodulation circuit 200, in which case the demodulated signal output from the FM demodulation circuit 200 may have a frequency close to 0 MHz. When the operating clock is 14.3 MHz, the demodulation mean frequency of the FM demodulation circuit 200 is set to 4.0 MHz, for example. Since the burst signal is originally 4.43 MHz and is higher than the mean frequency, the burst frequency discrimination signal output from the burst frequency discrimination circuit is supposed to be high. However, if a PAL signal having a very low signal amplitude is input, the demodulated signal output from the FM demodulation circuit 200 will have a frequency of 0 MHz, and the burst frequency discrimination signal will be low, thus resulting in an erroneous determination.

In view of this, the burst frequency discrimination circuit of the present embodiment uses the clock switching signal so that the SECAM BPF circuit 20 is selected when the operating clock is 17.7 MHz and the broad-band BPF circuit 50 is selected when the operating clock is 14.3 MHz.

The broad-band BPF circuit 50 has frequency characteristics such that it passes signals having frequencies from 2.45 MHz to 4.5 MHz, for example. Thus, where the operating clock is 14.3 MHz, even if a PAL signal having a very low signal amplitude is input, the amplitude is not attenuated through the broad-band BPF circuit 50, whereby the demodulated signal output from the FM demodulation circuit 200 has a frequency of 4.43 MHz, and the burst frequency discrimination signal output from the burst frequency discrimination circuit indicates a normal value.

As described above, the burst frequency discrimination circuit of the present embodiment additionally includes the broad-band BPF circuit 50 as a bandpass filter for separating the chroma signal from the input picture signal. Using the clock switching signal, the SECAM BPF circuit 20 is selected when the operating clock is 17.7 MHz and the broad-band BPF circuit 50 is selected when the operating clock is 14.3 MHz, whereby a demodulation operation is performed by the FM demodulation circuit 200 without attenuating the frequency component of the burst signal through the bandpass filter section. Using the BGP signal output from the trace-type BGP generation circuit 42, the burst extracting circuit 14 extracts the burst signal portion, and the demodulated signal of the extracted burst signal portion is integrated by the integration circuit 16 and compared with the predetermined value 15 by the comparator 19, the result of which is output as the burst frequency discrimination signal. Therefore, it is possible to instantaneously make a determination and output a burst frequency discrimination signal with a high precision even if the input signal has a low amplitude or a shifted burst position.

1. A burst frequency discrimination circuit to which a single operating clock is input, comprising:
a bandpass filter circuit for separating a chroma signal from an input picture signal;
a line synchronizing separation circuit for separating a horizontal synchronizing signal from the input picture signal;
a burst gate pulse generation circuit for generating a burst gate pulse based on the horizontal synchronizing signal separated by the line synchronizing separation circuit;
an FM demodulation circuit for demodulating the chroma signal output from the bandpass filter circuit to obtain a frequency component;
a SECAM color-difference demodulation circuit for demodulating the demodulated signal output from the FM demodulation circuit to obtain a SECAM color-difference signal;
a burst extracting circuit for extracting a burst signal portion as a burst demodulated signal from the demodulated signal output from the FM demodulation circuit using the burst gate pulse output from the burst gate pulse generation circuit as a reference; and
a comparison circuit for comparing the burst demodulated signal output from the burst extracting circuit with a predetermined value.

2. The burst frequency discrimination circuit of claim 1, wherein the FM demodulation circuit includes:
a Hilbert conversion circuit for converting the chroma signal from the bandpass filter circuit to a signal whose phase is shifted by 90° with respect to that of the chroma signal;
an arc tangent circuit for receiving an output from the Hilbert conversion circuit;
a differentiation circuit for differentiating an output signal from the arc tangent circuit; and
a deviation circuit for converting an output signal from the differentiation circuit to a signal having a predetermined mean frequency.

3. A burst frequency discrimination circuit, comprising:
a clock switching circuit for receiving a clock switching signal and switching an operating clock of the burst frequency discrimination circuit between a 17.7-MHz clock and a 14.3-MHz clock based on the received clock switching signal;
a bandpass filter circuit for separating a chroma signal from an input picture signal;
a line synchronizing separation circuit for separating a horizontal synchronizing signal from the input picture signal;
a burst gate pulse generation circuit for generating a burst gate pulse based on the horizontal synchronizing signal separated by the line synchronizing separation circuit;
a variable-type FM demodulation circuit for demodulating the chroma signal output from the bandpass filter circuit to obtain a frequency component, wherein a demodulation mean frequency can be varied by the clock switching signal in the demodulation process;
a SECAM color-difference demodulation circuit for demodulating the demodulated signal output from the variable-type FM demodulation circuit to obtain a SECAM color-difference signal where the input picture signal is a SECAM signal;
an NTSC/PAL color-difference demodulation circuit for demodulating the input picture signal where the input picture signal is an NTSC signal or a PAL signal;
a burst extracting circuit for extracting a burst signal portion as a burst demodulated signal from the demodulated signal output from the variable-type FM demodulation circuit using the burst gate pulse output from the burst gate pulse generation circuit as a reference; and
a comparison circuit for comparing the burst demodulated signal output from the burst extracting circuit with a predetermined value.

4. The burst frequency discrimination circuit of claim 3, wherein:
the line synchronizing separation circuit is of a rising-edge-detecting type, and separates a horizontal synchronizing signal from the input picture signal and detects a rising edge of the separated horizontal synchronizing signal; and
the burst gate pulse generation circuit generates the burst gate pulse based on the rising edge of the horizontal synchronizing signal detected by the line synchronizing separation circuit.

5. The burst frequency discrimination circuit of claim 3, wherein the line synchronizing separation circuit and the burst gate pulse generation circuit operate using a fixed clock as an operating clock, the fixed clock being not switched from one to another by the clock switching signal input to the clock switching circuit.

6. A burst frequency discrimination circuit, comprising:
a clock switching circuit for receiving a clock switching signal and switching an operating clock of the burst frequency discrimination circuit between a 17.7-MHz clock and a 14.3-MHz clock based on the received clock switching signal;
a bandpass filter circuit for separating a chroma signal from an input picture signal;
a line synchronizing separation circuit for separating a horizontal synchronizing signal from the input picture signal;
a pre-burst edge detection circuit for detecting a start position of a burst signal from the line synchronizing separation circuit to output a pre-burst edge detection signal;
a trace-type burst gate pulse generation circuit for generating a burst gate pulse following a burst signal position using the pre-burst edge detection signal output from the pre-burst edge detection circuit as a reference;
a variable-type FM demodulation circuit for demodulating the chroma signal output from the bandpass filter circuit to obtain a frequency component, wherein a demodulation mean frequency can be varied by the clock switching signal in the demodulation process;
a SECAM color-difference demodulation circuit for demodulating the demodulated signal output from the variable-type FM demodulation circuit to obtain a SECAM color-difference signal;
a burst extracting circuit for extracting a burst signal portion as a burst demodulated signal from the demodulated signal output from the variable-type FM demodulation circuit using the burst gate pulse output from the trace-type burst gate pulse generation circuit as a reference; and
a comparison circuit for comparing the burst demodulated signal output from the burst extracting circuit with a predetermined value.

7. The burst frequency discrimination circuit of claim 6, further comprising:
an additional bandpass filter circuit, provided in addition to the bandpass filter circuit, for separating a broad-band chroma signal from the input picture signal; and
a bandpass filter switching circuit for switching between the bandpass filter circuit and the additional bandpass filter circuit by using a clock switching signal.

8. The burst frequency discrimination circuit of claim 7, wherein the bandpass filter switching circuit selects the bandpass filter circuit when the clock switching circuit selects the 17.7-MHz clock and selects the additional bandpass filter circuit when the clock switching circuit selects the 14.3-MHz clock.

9. The burst frequency discrimination circuit of claim 3, wherein the variable-type FM demodulation circuit includes:
a Hilbert conversion circuit for converting the chroma signal from the bandpass filter circuit to a signal whose phase is shifted by 90° with respect to that of the chroma signal;
an arc tangent circuit for receiving an output from the Hilbert conversion circuit;
a differentiation circuit for differentiating an output signal from the arc tangent circuit; and
a mean-frequency-switching-type deviation circuit for, when the clock switching circuit selects the 14.3-MHz clock, variably setting the demodulation mean frequency so that the demodulation mean frequency is lowered as compared with a case where the 17.7-MHz clock is selected, and converting an output signal from the differentiation circuit to a signal of the variably-set demodulation mean frequency.

10. The burst frequency discrimination circuit of claim 6, wherein the variable-type FM demodulation circuit includes:
a Hilbert conversion circuit for converting the chroma signal from the bandpass filter circuit to a signal whose phase is shifted by 90° with respect to that of the chroma signal;
an arc tangent circuit for receiving an output from the Hilbert conversion circuit;
a differentiation circuit for differentiating an output signal from the arc tangent circuit; and
a mean-frequency-switching-type deviation circuit for, when the clock switching circuit selects the 14.3-MHz clock, variably setting the demodulation mean frequency so that the demodulation mean frequency is lowered as compared with a case where the 17.7-MHz clock is selected, and converting an output signal from the differentiation circuit to a signal of the variably-set demodulation mean frequency.
